(19) United States
(12) Patent Application Publication
(10) Pub. No.: US 2013/0293741 A1
(43) Pub. Date: Nov. 7, 2013

(54) IMAGE PROCESSING APPARATUS, IMAGE CAPTURING APPARATUS, AND STORAGE MEDIUM STORING IMAGE PROCESSING PROGRAM

(71) Applicant: Takeshi Nishi, Yokohama-shi (JP)

(72) Inventor: Takeshi Nishi, Yokohama-shi (JP)

(73) Assignee: NIKON CORPORATION, Tokyo (JP)

(21) Appl. No.: 13/977,829

(22) PCT Filed: Jan. 6, 2012
(86) PCT No.: PCT/JP2012/000066

§ 371 Date: Jul. 1, 2013

(30) Foreign Application Priority Data
Jan. 6, 2011 (JP) 2011-001278

(51) Int. Cl. H04N 5/225

(52) U.S. Cl. CPC H04N 5/225
USPC 348/222.1

(57) ABSTRACT

There are provided a feature amount acquisition unit acquiring feature amounts of focused states of a first image and a second image which are captured in time-series; a calculation unit dividing each of the first image and the second image into a plurality of image areas and determining a frequency distribution of a feature amount for each of the image areas; and a motion detection unit calculating a difference between the frequency distribution of the first image and that of the second image for each of the image areas and detecting a motion of a subject based on a frequency distribution of the difference for each of the image areas.

### TECHNICAL FIELD

The present application relates to an image processing apparatus, an image capturing apparatus, and an image processing program capable of detecting a motion of a subject.

### BACKGROUND ART

Conventionally, a method of optical flow, for example, has been used for detecting a motion of a subject from images continuously captured in time-series, such as a moving image (refer to Patent Document 1 and the like).

### PRIOR ART DOCUMENT

### Patent Document

Patent Document 1: Japanese Unexamined Patent Application Publication No. 2010-134606

### DISCLOSURE OF THE INVENTION

### Problems to be Solved by the Invention

However, in the conventional technique of detecting the motion of the subject by using the method of optical flow or the like, there are problems that an enormous calculation amount is required, resulting in that a circuit scale is increased, and it takes a long time.

In view of the problems of the conventional technique described above, a proposition of the present application is to provide a technique with which a motion of a subject can be detected at high speed and with good accuracy, without increasing a circuit scale.

### Means for Solving the Problems

In order to solve the above-described problems, one aspect of an image processing apparatus exemplifying the present embodiment includes a feature amount acquisition unit acquiring feature amounts of focused states of a first image and a second image which are captured in time-series, a calculation unit dividing each of the first image and the second image into a plurality of image areas and determining a frequency distribution of a feature amount for each of the image areas, and a motion detection unit calculating a difference between the frequency distribution of the first image and that of the second image for each of the image areas and detecting a motion of a subject based on a frequency distribution of the difference for each of the image areas.

Further, it is also possible that the motion detection unit detects the motion of the subject based on a variation of frequency of the feature amount which is equal to or less than a first threshold and the feature amount which is equal to or greater than a second threshold which is larger than the first threshold in the frequency distribution of the difference.

Further, it is also possible that a subject recognition unit recognizing the subject in the first image and the second image is provided, and the motion detection unit detects a direction of the motion of the subject based on the frequency distribution of the difference and a size of area of the subject being recognized.

Further, it is also possible that the motion detection unit determines a size of area of the subject based on a correlation between frequency distributions of an image area to be processed and a peripheral image area, and detects a direction of the motion of the subject based on the frequency distribution of the difference and the size of area of the subject.

Further, it is also possible that the feature amount acquisition unit acquires the feature amounts by using a filter determined with a sampling function.

Further, it is also possible that there is provided a threshold learning unit performing learning with the first image and the second image as new supervised data and updating values of the first threshold and the second threshold.

Further, it is also possible that there are provided a storage unit storing values of the first threshold and the second threshold for each scene, a scene recognition unit recognizing a scene captured in the first image and the second image, and a threshold configuration unit configuring the values of the first threshold and the second threshold in accordance with the scene being recognized.

Another aspect of the image processing apparatus exemplifying the present embodiment includes an acquisition unit acquiring information on focused states of a first image and a second image being captured, a comparison unit comparing the focused states in respective corresponding areas of the first image and the second image, and a motion detection unit detecting a motion of a subject based on a comparison result of the focused states acquired by the comparison unit.

One aspect of an image capturing apparatus exemplifying the present embodiment includes an imaging unit generating an image by capturing an image of a subject, and the image processing apparatus of the present embodiment.

One aspect of an image processing program exemplifying the present embodiment causes a computer to execute an input step inputting a first image and a second image which are captured in time-series, a feature amount acquisition step acquiring feature amounts of focused states of the first image and the second image, a calculation step dividing each of the first image and the second image into a plurality of image areas and determining a frequency distribution of a feature amount for each of the image areas, and a motion detection step calculating a difference between the frequency distribution of the first image and that of the second image for each of the image areas and detecting a motion of a subject based on a frequency distribution of the difference for each of the image areas.

Another aspect of the image processing program exemplifying the present embodiment causes a computer to execute an acquisition step acquiring information on focused states of a first image and a second image being captured, a comparison step comparing the focused states in respective corresponding areas of the first image and the second image, and a motion detection step detecting a motion of a subject based on a comparison result of the focused states acquired by the comparison step.

According to the present embodiment, it is possible to detect a motion of a subject at high speed and with good accuracy, without increasing a circuit scale.

### BRIEF DESCRIPTION OF THE DRAWINGS

FIG. 1 is a block diagram illustrating an example of configuration of a digital camera according to one embodiment.

FIG. 2 is a diagram illustrating an example of a filter for performing a convolution operation with a frame.

FIG. 3 are diagrams illustrating examples of frequency distributions of a current frame and a past frame, and a frequency distribution of a difference.

FIG. 4 is a flow chart illustrating an example of processing operation performed by the digital camera according to the one embodiment.

FIG. 5 is a block diagram illustrating an example of configuration of a digital camera according to another embodiment.

FIG. 6 is a flow chart illustrating an example of processing operation performed by the digital camera according to the other embodiment.

### BEST MODE FOR CARRYING OUT THE INVENTION

### One Embodiment

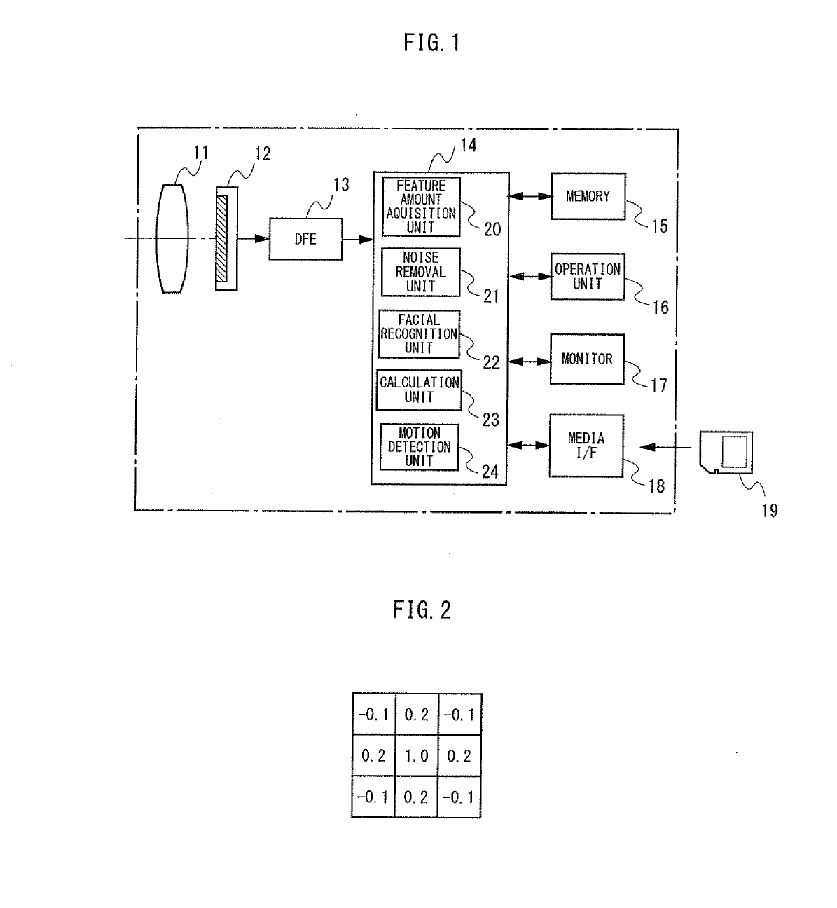

FIG. 1 is a block diagram illustrating one example of configuration of a digital camera according to one embodiment of the present invention.

A digital camera of the present embodiment has an imaging lens 11, an imaging sensor 12, a DFE 13, a CPU 14, a memory 15, an operation unit 16, a monitor 17, and a media interface (media I/F) 18. The DFE 13, the memory 15, the operation unit 16, the monitor 17, and the media I/F 18 are respectively connected to the CPU 14.

The imaging sensor 12 is a device that captures a subject image formed by a light flux passed through the imaging lens 11. An output of the imaging sensor 12 is input into the DFE 13. Note that the imaging sensor 12 of the present embodiment may be a sequential scanning solid-state imaging sensor (CCD or the like), or may also be an XY address type solid-state imaging sensor (CMOS or the like).

Further, on a light receiving surface of the imaging sensor 12, a plurality of light receiving elements are arranged in a matrix form. On each of the light receiving elements of the imaging sensor 12, color filters of red color (R), green color (G), and blue color (B) are arranged in accordance with a well-known Bayer pattern. For this reason, the respective light receiving elements of the imaging sensor 12 output image signals corresponding to respective colors, through color separation in the color filters. Accordingly, the imaging sensor 12 can acquire a color image.

Here, when capturing an image by using the digital camera, the imaging sensor 12 captures the above-described color image (main image) in response to a full depression operation of release button of the operation unit 16. Further, the imaging sensor 12 in a shooting mode captures an image for composition confirmation (through image) at every predetermined interval also at a time of imaging standby. Data of the through image is output by thinning-out reading from the imaging sensor 12. Note that the data of the through image is used for an image display on the monitor 17, and various types of calculation processing performed by the CPU 14, as will be described later.

The DFE 13 is a digital front-end circuit that performs A/D conversion of an image signal input from the imaging sensor 12, and signal processing such as defective pixel correction. The DFE 13 forms an imaging unit together with the imaging sensor 12 in the present embodiment, and outputs the image signal input from the imaging sensor 12 to the CPU 14 as image data.

The CPU 14 is a processor that comprehensively controls respective parts of the digital camera. For instance, the CPU 14 executes each of auto-focus (AF) control using well-known contrast detection, well-known automatic exposure (AE) calculation and the like, based on an output of the imaging sensor 12. Further, the CPU 14 performs, on image data from the DEF 13, digital processing such as interpolation processing, white balance processing, gradation conversion processing, edge enhancement processing, and color conversion processing.

Further, when an image processing program is executed, the CPU 14 of the present embodiment operates as a feature amount acquisition unit 20, a noise removal unit 21, a facial recognition unit 22, a calculation unit 23, and a motion detection unit 24.

The feature amount acquisition unit 20 performs, on a through image and a frame of moving image captured by the digital camera, a convolution operation using a filter formed of an array of coefficients determined based on a sampling function, to thereby calculate a feature amount indicating a focused state. Here, in the present embodiment, a PSF (Point Spread Function) represented by the following expression (1) is used as the sampling function, and a filter of an array of coefficients such as illustrated in FIG. 2, for example, determined based on the PSF is used.

$$\begin{matrix}[ Mathematical expression 1 ] & \\ PSF ( x , y ) = \frac{sin ( π x )}{π x} \times \frac{sin ( π y )}{π y} & ( 1 )\end{matrix}$$

Note that as the PSF, one with a diameter small enough to capture a very small blur in the vicinity of focus point within a depth of field is preferably used, and a size of the filter is preferably set to 3 pixels×3 pixels, 5 pixels×5 pixels, or the like.

Through a convolution operation, using the filter illustrated in FIG. 2, with respect to pixel values of an area having a size of 3 pixels×3 pixels in which a pixel position of an attention pixel of frame is set as a center, the feature amount acquisition unit 20 acquires a feature amount (referred to as “gain”, hereinafter) indicating a focused state in the attention pixel. Here, a pixel positioned within the depth of field has a value of large gain (high gain), and a pixel positioned outside the depth of field has a value of small gain (low gain). The feature amount acquisition unit 20 outputs a frame in which gains are set as pixel values.

The noise removal unit 21 applies a well-known noise removal method such as morphological processing, for example, to the frame output from the feature amount acquisition unit 20, to thereby remove particularly spike-shaped noise.

The facial recognition unit 22 recognizes, as a subject recognition unit, a face of captured person (subject) by applying facial recognition processing to the frame. This facial recognition processing is performed through a well-known algorithm. As an example, the facial recognition unit 22 extracts, from the frame, feature points such as respective end points of eyebrows, eyes, nose, and lips, through well-known feature point extraction processing, and judges whether or not there exists a facial area, based on these feature points. Alternatively, it is also possible that the facial recognition unit 22 determines a correlation coefficient between a previously prepared facial image or the like and a frame to be judged, and judges, when the correlation coefficient exceeds a certain threshold, that the facial area exists.

The calculation unit 23 divides the frame into image areas whose number is M×N, and determines a frequency distribution of gains for each of the image areas. Here, M and N are set as natural numbers.

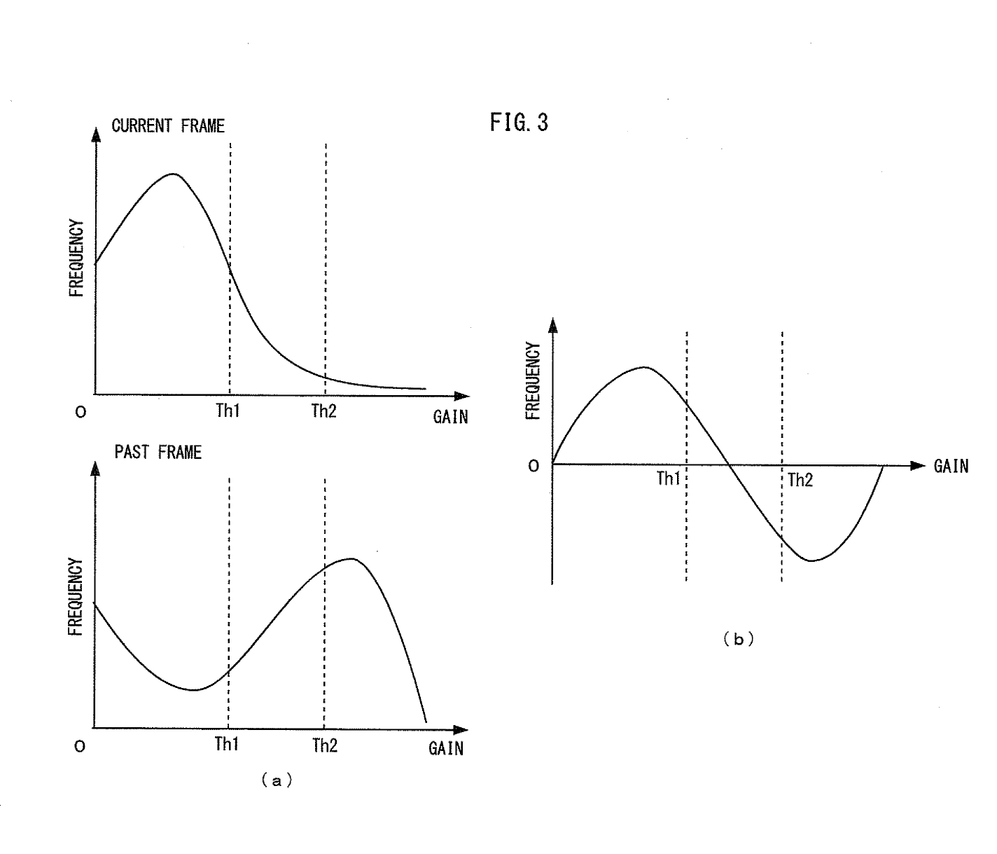

The motion detection unit 24 calculates a difference between the frequency of gains of a current frame (first image) and that of a past frame (second image) which is one frame before the current frame, for each of the image areas, and detects a motion of the subject based on a frequency distribution of the difference. For example, when the frequency distribution of gains of the current frame and that of the past frame in the image area to be processed are represented as illustrated in FIG. 3(a), the frequency distribution of the difference is represented as illustrated in FIG. 3(b). Note that in the present embodiment, the gain equal to or less than a threshold Th1 (first threshold) is set as a low gain, and the gain equal to or greater than a threshold Th2 (second threshold) is set as a high gain.

As illustrated in FIG. 3(b), in a case where the frequency of low gains is increased and the frequency of high gains is decreased, the motion detection unit 24 detects that case as a motion of “out” in which the subject moves on a screen and gets out of the image area to be processed to enter an adjacent image area, or the subject moves in a direction of sight line from within the depth of field to the outside the depth of field. Further, in a case where the frequency of low gains is decreased and the frequency of high gains is increased, the motion detection unit 24 detects that case as a motion of “in” in which the subject moves on the screen to enter the image area to be processed from the adjacent image area, or the subject moves in the direction of sight line from the outside the depth of field to the within the depth of field. Further, as will be described later, the motion detection unit 24 performs not only the detection of the motion of the subject but also the detection of the direction of the motion, by using a facial recognition result acquired by the facial recognition unit 22.

Note that the thresholds Th1 and Th2 are set to values which are previously determined by performing learning by applying, for example, 1000 to 10000 sample images to a well-known learning method as supervised data.

The memory 15 is a nonvolatile semiconductor memory storing various types of programs such as a control program and the image processing program executed by the CPU 14, together with the image data of the frame and the thresholds Th1 and Th2.

The operation unit 16 receives, from a user, an input of switching setting of an imaging mode, an instruction to capture a still image, perform continuous shooting or capture a moving image, and the like, for example.

The monitor 17 is a monitor such as a liquid crystal monitor, and displays various types of images in accordance with a control instruction made by the CPU 14.

To the media I/F 18, a nonvolatile computer readable medium 19 can be detachably connected. Further, the media I/F 18 executes writing/reading of data into/from the computer readable medium 19. The above-described computer readable medium 19 is formed of a hard disk, a memory card having a semiconductor memory built therein or the like. Note that in FIG. 1, a memory card is illustrated as an example of the computer readable medium 19.

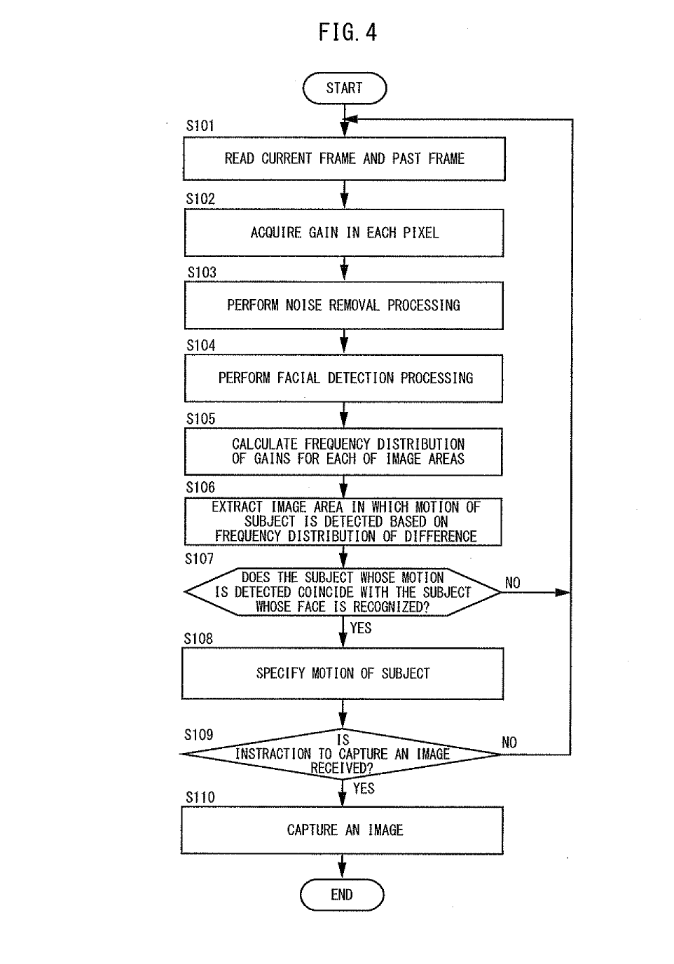

Next, a processing operation performed by the digital camera according to the present embodiment will be explained, while referring to a flow chart in FIG. 4. Note that in the description hereinbelow, an image to be processed is set to a through image.

Upon receiving, from a user, a power-on instruction of the digital camera (push operation of power button included in the operation unit 16 or the like, for example), the CPU 14 executes the control program and the image processing program. These control program and image processing program are recorded in the memory 15, for example. The CPU 14 makes the imaging sensor 12 start capturing a through image, and displays the through image on the monitor 17. The CPU 14 starts processing from step S101.

Step S101: The CPU 14 reads, from the DFE 13, the through image captured by the imaging sensor 12 as a current frame (first image). At the same time, the CPU 14 reads a through image captured one frame before the current frame and recorded in a not-illustrated internal memory, as a past frame (second image).

Step S102: The feature amount acquisition unit 20 performs, on each of the current frame and the past frame, a convolution operation using a filter such as illustrated in FIG. 2, to thereby acquire a gain in an attention pixel. The feature amount acquisition unit 20 outputs the current frame and the past frame formed of the gains.

Step S103: The noise removal unit 21 performs noise removal processing on the current frame and the past frame output from the feature extraction unit 20.

Step S104: The facial recognition unit 22 performs facial detection processing on each of the current frame and the past frame. The facial recognition unit 22 records, for each of the frames, a recognized facial area in the internal memory (not illustrated) as facial data.

Step S105: The calculation unit 23 divides each of the current frame and the past frame into image areas whose number is M×N, and determines a frequency distribution of gains for each of the image areas.

Step S106: The motion detection unit 24 calculates, for each of the image areas, a difference between the frequency distribution of the current frame and that of the past frame, and judges, based on the frequency distribution of the difference, whether or not the subject is moved. Specifically, when a variation of frequency of the low gains and the high gains is not 0 as illustrated in FIG. 3(b), for example, the motion detection unit 24 judges that the subject in the image area is moved. On the other hand, when the variation of frequency of the low gains and the high gains is 0, the motion detection unit 24 judges that the subject is not moved. The motion detection unit 24 performs judgment on all of the image areas, extracts the image area in which the motion of the subject is detected, and records the extracted image area in the internal memory (not illustrated).

Step S107: The motion detection unit 24 judges whether or not the subject whose motion is detected in step S106 and the subject whose face is recognized in step S104 are the same subject. The motion detection unit 24 judges whether or not the facial area of the subject whose face is recognized coincides with the image area in which the motion is detected. When the facial area coincides with the image area, the motion detection unit 24 judges that the subject whose motion is detected is the subject whose face is recognized. The CPU 14 highlight-displays the facial area of the subject whose motion is detected, on the monitor 17, for example. The CPU 14 makes the processing proceed to step S108 (YES side).

On the other hand, when the facial area does not coincide with the image area, the motion detection unit 24 judges that the subject whose motion is detected is not the subject whose face is recognized and is a tree or the like in a background, and the CPU 14 makes the processing proceed to step S101 (NO side).

Step S108: The motion detection unit 24 specifies the motion of the subject based on the detection result and the facial recognition result. The motion detection unit 24 judges whether or not a size of the facial area of the subject is changed between the current frame and the past frame. When the size of the facial area is increased, the motion detection unit 24 specifies that the subject moves in a direction in which he/she comes toward the digital camera in the direction of sight line. On the other hand, when the size of the facial area is decreased, the motion detection unit 24 specifies that the subject moves in a direction in which he/she moves away from the digital camera in the direction of sight line.

Meanwhile, when the size of the facial area is not changed, the motion detection unit 24 specifies that the subject moves on the screen.

Note that it is also possible that the motion detection unit 24 determines a gravity center position of the facial area in each of the frames, and specifies a direction in which the gravity center position is changed between the current frame and the past frame, as a direction of the motion on the screen, for example.

The CPU 14 applies the acquired result of motion detection to a well-known background estimation method or main subject estimation method, to thereby separate a background and a main subject, for example. The CPU 14 performs, in an image area of the main subject, an AF control, an AE calculation, an auto white balance (AWB) calculation, a color process control and the like, or it performs object recognition processing of the main subject.

Step S109: The CPU 14 judges whether or not it receives, from a user, an instruction to capture an image (full depression operation of release button included in the operation unit 16 or the like, for instance). When the CPU 14 does not receive the instruction to capture the image, it records a current frame in the memory 15 as a past frame, and the processing proceeds to step S101 (NO side). On the other hand, when the CPU 14 receives the instruction to capture the image, the processing proceeds to step S110 (YES side).

Step S110: The CPU 14 captures an image of main subject. Note that when a moving image is captured, the CPU 14 preferably sets, during the capturing of moving image, respective frames of moving image as a current frame and a past frame, similar to the case of the through image, and performs processing similar to that from step S101 to step S108. During the capturing of images, the CPU 14 preferably performs, on the main subject, not only the AF control and the like described above but also a subject tracking, an electronic camera-shake control, an auto zoom and the like. Further, when the CPU 14 receives an instruction to terminate the capturing of images, it terminates the series of processing.

As described above, in the present embodiment, by performing the convolution operation on each frame using the filter determined based on the sampling function to determine the frequency distribution of gains for each image area, and detecting the motion of the subject based on the frequency distribution of the difference of gains between the frames, it is possible to detect the motion of the subject with a small calculation amount, at high speed and with good accuracy, compared to the conventional technique of optical flow or the like.

Further, since the calculation amount is small, it is possible to avoid the increase in the circuit scale of the digital camera.

Further, by combining the above-described detection result and the facial recognition result, it is possible to easily detect the motion of the subject in a three-dimensional manner.

### Another Embodiment

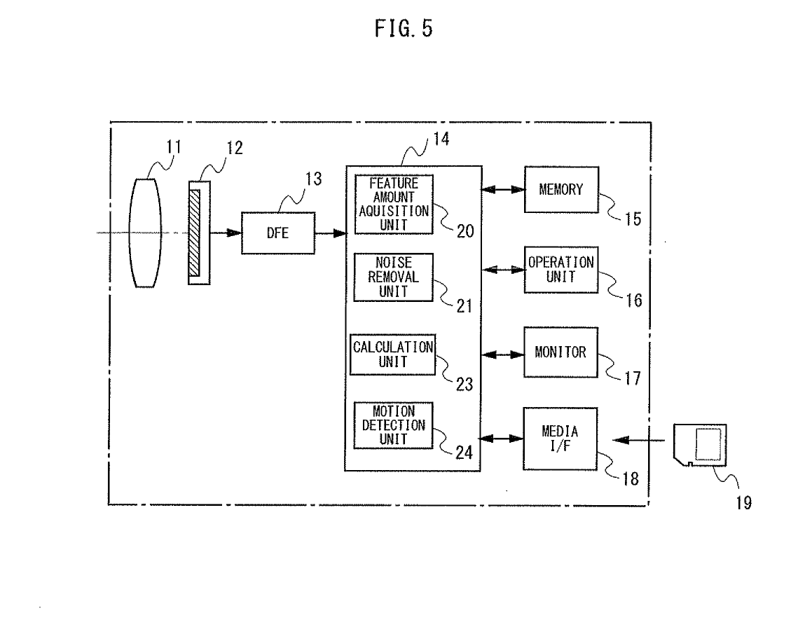

FIG. 5 is a block diagram illustrating an example of configuration of a digital camera according to another embodiment of the present invention. In the digital camera according to the present embodiment, the same configuration as that of the digital camera according to the one embodiment illustrated in FIG. 1 is denoted by the same reference numeral, and detailed explanation thereof will be omitted.

The digital camera according to the present embodiment is different from the digital camera according to the one embodiment in that the facial recognition unit 22 is omitted, and the motion detection unit 24 calculates, in each of a current frame and a past frame, a correlation of a frequency distribution of gains in an image area to be processed and that in a peripheral image area, and recognizes a subject based on a result of the correlation.

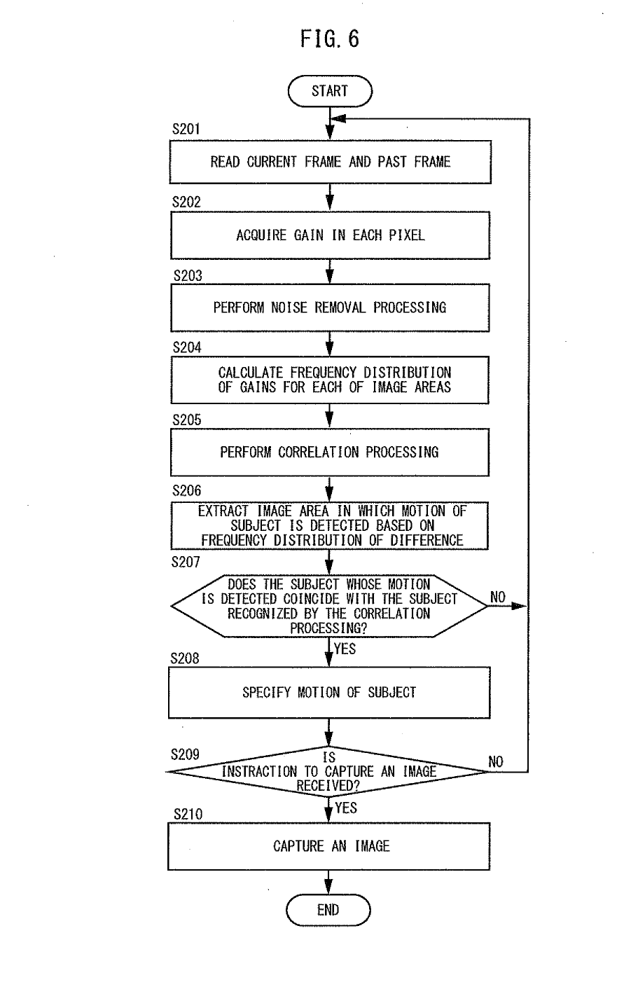

Accordingly, a processing operation performed by the digital camera according to the present embodiment will be described while referring to a flow chart in FIG. 6. Note that in the explanation hereinbelow, an image to be processed is set to a through image, similar to the case of the one embodiment.

Upon receiving, from a user, a power-on instruction of the digital camera (push operation of power button included in the operation unit 16 or the like, for example), the CPU 14 executes the control program and the image processing program. These control program and image processing program are recorded in the memory 15, for example. The CPU 14 makes the imaging sensor 12 start capturing a through image, and displays the through image on the monitor 17. The CPU 14 starts processing from step S201.

Step S201: The CPU 14 reads, from the DFE 13, the through image captured by the imaging sensor 12 as a current frame. At the same time, the CPU 14 reads a through image captured one frame before the current frame and recorded in the not-illustrated internal memory, as a past frame.

Step S202: The feature amount acquisition unit 20 performs, on each of the current frame and the past frame, a convolution operation using a filter such as illustrated in FIG. 2, to thereby acquire a gain in an attention pixel. The feature amount acquisition unit 20 outputs the current frame and the past frame formed of the gains.

Step S203: The noise removal unit 21 performs noise removal processing on the current frame and the past frame output from the feature extraction unit 20.

Step S204: The calculation unit 23 divides each of the current frame and the past frame into image areas whose number is M×N, and determines a frequency distribution of gains for each of the image areas.

Step S205: The motion detection unit 24 judges, based on a correlation regarding shapes of the frequency distribution in an attention image area and that in an image area in the periphery of the attention image area, particularly, a correlation regarding shapes of the frequency distributions of high gains, in each of the current frame and the past frame, whether or not a subject in the attention image area and a subject in the image area in the periphery of the attention image area are the same subject. Specifically, when a correlation coefficient in the frequency distributions of high gains is equal to or greater than a predetermined value, the motion detection unit 24 judges that the subject in the attention image area and the subject in the image area in the periphery of the attention image area are the same subject. On the other hand, when the correlation coefficient in the frequency distributions of high gains is less than the predetermined value, the motion detection unit 24 judges that the subject in the attention image area and the subject in the image area in the periphery of the attention image area are different. Further, the motion detection unit 24 performs correlation processing on all of the image areas of the current frame and the past frame, extracts the image areas in which the subjects are judged to be the same, and records the extracted image areas in the internal memory (not illustrated).

Note that it is preferable that when the motion detection unit 24 judges whether the subjects are the same or not, it performs the judgment also by using color component information possessed by the subject, and the like, for example. Further, in the present embodiment, a size of each of the image areas in which the subjects are judged to be same, is set to a size of the subject recognized by the correlation processing.

Step S206: The motion detection unit 24 calculates, for each of the image areas, a difference between the frequency distribution of the current frame and that of the past frame, and judges, based on the frequency distribution of the difference, whether or not the subject is moved. Specifically, when a variation of frequency of the low gains and the high gains is not 0 as illustrated in FIG. 3(b), for example, the motion detection unit 24 judges that the subject in the image area is moved. On the other hand, when the variation of frequency of the low gains and the high gains is 0, the motion detection unit 24 judges that the subject is not moved. The motion detection unit 24 performs judgment on all of the image areas, extracts the image area in which the motion of the subject is detected, and records the extracted image area in the internal memory (not illustrated).

Step S207: The motion detection unit 24 judges whether or not the subject whose motion is detected in step S206 and the subject recognized in step S205 are the same subject. The motion detection unit 24 judges whether or not the image area of the subject recognized by the correlation processing coincides with the image area in which the motion is detected. When the image areas coincide with each other, the motion detection unit 24 judges that the subject whose motion is detected is the subject recognized by the correlation processing. The CPU 14 highlight-displays the image area of the subject whose motion is detected, on the monitor 17, for example. The CPU 14 makes the processing proceed to step S208 (YES side).

On the other hand, when the image areas do not coincide with each other, the motion detection unit 24 judges that the subject whose motion is detected is not the subject recognized by the correlation processing and is a tree or the like in a background, and the CPU 14 makes the processing proceed to step S201 (NO side).

Step S208: The motion detection unit 24 specifies the motion of the subject based on the detection result and the correlation result. The motion detection unit 24 judges whether or not a size of the subject recognized by the correlation processing is changed between the current frame and the past frame. When the size of the subject is increased, the motion detection unit 24 specifies that the subject moves in a direction in which he/she comes toward the digital camera in the direction of sight line. On the other hand, when the size of the subject is decreased, the motion detection unit 24 specifies that the subject moves in a direction in which he/she moves away from the digital camera in the direction of sight line. Meanwhile, when the size of the subject is not changed, the motion detection unit 24 specifies that the subject moves on the screen.

Note that it is also possible that the motion detection unit 24 determines a gravity center position of the image area of the subject recognized by the correlation processing in each of the frames, and specifies a direction in which the gravity center position is changed between the current frame and the past frame, as a direction of the motion on the screen.

The CPU 14 applies the acquired result of motion detection to a well-known background estimation method or main subject estimation method, to thereby separate a background and a main subject, for example. The CPU 14 performs, in an image area of the main subject, an AF control, art AE calculation, an auto white balance (AWB) calculation, a color process control and the like, or it performs object recognition processing of the main subject.

Step S209: The CPU 14 judges whether or not it receives, from a user, an instruction to capture an image (full depression operation of release button included in the operation unit 16 or the like, for instance). When the CPU 14 does not receive the instruction to capture the image, it records a current frame in the memory 15 as a past frame, and the processing proceeds to step S201 (NO side). On the other hand, when the CPU 14 receives the instruction to capture the image, the processing proceeds to step S210 (YES side).

Step S210: The CPU 14 captures an image of main subject. Note that when a moving image is captured, the CPU 14 preferably sets, during the capturing of moving image, respective frames of moving image as a current frame and a past frame, similar to the case of the through image, and performs processing similar to that from step S201 to step S208. During the capturing of images, the CPU 14 preferably performs, on the main subject, not only the AF control and the like described above but also a subject tracking, an electronic camera-shake control, an auto zoom, and the like. Further, when the CPU 14 receives an instruction to terminate the capturing of images, it terminates the series of processing.

As described above, in the present embodiment, by performing the convolution operation on each frame using the filter determined based on the sampling function to determine the frequency distribution of gains for each image area, and detecting the motion of the subject based on the frequency distribution of the difference of gains between the frames, it is possible to detect the motion of the subject with a small calculation amount, at high speed and with good accuracy, compared to the conventional technique of optical flow or the like.

Further, since the calculation amount is small, it is possible to avoid the increase in the circuit scale of the digital camera.

Further, by combining the above-described detection result and the correlation result, it is possible to easily detect the motion of the subject in a three-dimensional manner.

<<Supplemental Matters to Embodiments>>

(1) The aforementioned embodiments explain an example in which the respective processings performed by the feature amount acquisition unit 20, the noise removal unit 21, the facial recognition unit 22, the calculation unit 23, and the motion detection unit 24, are realized as software by the CPU 14, but, it is also possible that these respective processings are realized as hardware by using an ASIC.

(2) The image processing apparatus of the present invention is not limited to an example of the digital camera of the aforementioned embodiments. For example, it is also possible to make a computer read a moving image, and to make the computer execute the image processing program, thereby making the computer operate as the image processing apparatus of the present invention.

(3) In the above-described embodiments, the processing is performed by using the value of gain determined by the feature extraction unit 20 as it is, but, the present invention is not limited to this. For example, it is also possible that the feature extraction unit 20 sets a value as a result of normalizing the value of gain determined by using the filter as illustrated in FIG. 2 by a maximum value of gain in the frame, as a gain. Accordingly, it is possible to avoid an error detection such that the subject is seemingly moved, due to the change in gains because of the change in brightness since, for example, the weather changes from fine to cloudy weather, even when the digital camera captures the same scene.

(4) In the above-described embodiments, the thresholds Th1 and Th2 are set as fixed values, but, the present invention is not limited to this. For example, it is also possible that the CPU 14 performs learning by using the current frame and the past frame as new supervised data, to thereby update values of the thresholds Th1 and Th2.

Further, it is also possible that the memory 15 stores, as the values of the thresholds Th1 and Th2, values in accordance with an imaging scene of night landscape, portrait or the like, and the CPU 14 recognizes a scene captured in a frame, and determines and configures the values of the thresholds Th1 and Th2 to be used, in accordance with a result of the scene recognition. In this case, when performing learning by using the current frame and the past frame as new supervised data; the CPU 14 preferably recognizes a scene in the current frame and the past frame, and updates the values of the thresholds Th1 and Th2 in the recognized scene.

(5) The above-described embodiments employ the array of coefficients determined based on the PSF being one of the sampling functions, as the filter as illustrated in FIG. 2, but, the present invention is not limited to this. For example, it is also possible to employ an array of coefficients determined by using a normal distribution function, a Laplace function or the like, as the filter.

(6) In the above-described embodiments, each of the current frame and the past frame is divided into the image areas whose number is M×N, and the frequency distribution of gains is determined for each of the image areas (step S105). However, it is also possible that the calculation unit 23 determines a frequency distribution of gains of a partial area of each of the current frame and the past frame. At that time, the calculation unit 23 may determine the frequency distributions of gains of the corresponding areas of the current frame and the past frame.

(7) In the above-described embodiments and the supplemental matters to the embodiments, the areas in which the frequency distributions of gains are determined may not be exactly coincided with each other.

(8) In the above-described embodiments, the frequency distribution is determined for each image area, and the frequency distribution of the difference is calculated to detect the motion, but, the calculation of the difference does not always have to be conducted. For example, it is also possible to design such that focused states in respective corresponding areas of the current frame and the past frame are compared, and based on a result of the comparison of the focused states (change in the focused states), the motion of the subject is detected.

(9) It is also possible to design such that the control program and the image processing program illustrated in the flow charts in FIG. 4 and FIG. 6 in the above-described embodiments are downloaded into a digital camera or a personal computer to be executed. Further, it is also possible to design such that the programs are recorded in recording media such as CDs, DVDs, SD cards and the other semiconductor memories, and are executed by a camera or a personal computer.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

### EXPLANATION OF NUMERALS AND SYMBOLS

11 . . . Imaging lens, 12 . . . Imaging sensor, 13 . . . DEF, 14 . . . CPU, 15 . . . Memory, 16 . . . Operation unit, 17 . . . Monitor, 18 . . . Media I/F, 19 . . . Computer readable medium, 20 . . . Feature amount acquisition unit, 21 . . . Noise removal unit, 22 . . . Facial recognition unit, 23 . . . Calculation unit, 24 . . . Motion detection unit

1. An image processing apparatus, comprising:
a feature amount acquisition unit acquiring feature amounts of focused states of a first image and a second image which are captured in time-series;
a calculation unit dividing each of the first image and the second image into a plurality of image areas and determining a frequency distribution of feature amount for each of the image areas; and
a motion detection unit calculating a difference between the frequency distribution of the first image and the frequency distribution of the second image for each of the image areas and detecting a motion of a subject based on a frequency distribution of the difference for each of the image areas.

2. The image processing apparatus according to claim 1, wherein
the motion detection unit detects the motion of the subject based on a variation of frequency of the feature amount which is equal to or less than a first threshold and the feature amount which is equal to or greater than a second threshold which is larger than the first threshold in the frequency distribution of the difference.

3. The image processing apparatus according to claim 1, further comprising
a subject recognition unit recognizing the subject in the first image and the second image, wherein
the motion detection unit detects a direction of the motion of the subject based on the frequency distribution of the difference and a size of area of the subject being recognized.

4. The image processing apparatus according to claim 1, wherein
the motion detection unit determines a size of area of the subject based on a correlation between frequency distributions of an image area to be processed and a peripheral image area, and detects a direction of the motion of the subject based on the frequency distribution of the difference and the size of area of the subject.

5. The image processing apparatus according to claim 1, wherein
the feature amount acquisition unit acquires the feature amounts by using a filter determined with a sampling function.

6. The image processing apparatus according to claim 2, further comprising
a threshold learning unit performing learning with the first image and the second image as new supervised data and updating values of the first threshold and the second threshold.

7. The image processing apparatus according to claim 2, further comprising:
a storage unit storing values of the first threshold and the second threshold for each scene;
a scene recognition unit recognizing a scene captured in the first image and the second image; and
a threshold configuration unit configuring the values of the first threshold and the second threshold in accordance with the scene being recognized.

8. An image processing apparatus, comprising:
an acquisition unit acquiring information on focused states of a first image being captured and a second image being captured;
a comparison unit comparing the focused states in respective corresponding areas of the first image and the second image; and
a motion detection unit detecting a motion of a subject based on a comparison result of the focused states acquired by the comparison unit.

9. An image capturing apparatus, comprising:
an imaging unit generating an image by capturing an image of a subject; and
the image processing apparatus according to claim 1.

10. A non-transitory storage medium storing an image processing program causing a computer to execute:
inputting a first image and a second image which are captured in time-series;
acquiring feature amounts of focused states of the first image and the second image;
dividing each of the first image and the second image into a plurality of image areas and determining a frequency distribution of a feature amount for each of the image areas; and
calculating a difference between the frequency distribution of the first image and the frequency distribution of the second image for each of the image areas and detecting a motion of a subject based on a frequency distribution of the difference for each of the image areas.

11. A non-transitory storage medium storing an image processing program causing a computer to execute:
acquiring information on focused states of a first image being captured and a second image being captured;
comparing the focused states in respective corresponding areas of the first image and the second image; and
detecting a motion of a subject based on a comparison result of the focused states acquired by the comparing.

12. An image capturing apparatus, comprising:
an imaging unit generating an image by capturing an image of a subject; and
the image processing apparatus according to claim 8.
